(19) United States
(12) Patent Application Publication
(10) Pub. No.: US 2026/0052373 A1
(43) Pub. Date: Feb. 19, 2026

(54) SYSTEMS AND METHODS FOR WIRELESS NETWORK ACCESS CONTROL BASED ON USER EQUIPMENT CAPABILITY PARAMETERS

(71) Applicant: Verizon Patent and Licensing Inc., Basking Ridge, NJ (US)

(72) Inventors: Yousif Targali, Sammamish, WA (US); Said Soulhi, Saint Cloud, FL (US)

(73) Assignee: Verizon Patent and Licensing Inc., Basking Ridge, NJ (US)

(21) Appl. No.: 18/805,755

(22) Filed: Aug. 15, 2024

(51) Int. Cl. H04W 8/22; H04W 12/03; H04W 48/02

(52) U.S. Cl. CPC H04W 8/22; H04W 12/03; H04W 48/02

(57) ABSTRACT

A system described herein may receive a UE capability policy associated with a wireless network. The UE capability policy may include criteria indicating a particular set of UE capabilities. The system may receive a request for a UE access the wireless network; determine UE capability information associated with the UE; and compare the UE capability information to the criteria included in the UE capability policy to determine whether the UE implements the particular set of UE capabilities. The system may selectively grant or deny access to the UE in response to the request, wherein selectively granting or denying the access includes denying access to the UE when determining that the UE does not implement the particular set of UE capabilities, and granting access to the UE when determining that the UE implements the particular set of UE capabilities.

### BACKGROUND

Wireless networks provide wireless connectivity to User Equipment ("UEs"), such as mobile telephones, tablets, Internet of Things ("IoT") devices, Machine-to-Machine ("M2M") devices, or the like. UEs may have varying capabilities, such as implementing various cryptography techniques and/or parameters of such techniques (e.g., particular encryption algorithms or protocols, a quantity of bits used in encryption techniques, etc.), operating systems, libraries, application programming interfaces ("APIs"), software development kids ("SDKs"), etc.

### BRIEF DESCRIPTION OF THE DRAWINGS

FIG. 1 illustrates an example overview of one or more embodiments described herein;

FIG. 2 illustrates an example of redirecting an access request based on UE capability information, in accordance with some embodiments;

FIG. 3 illustrates an example of modifying UE capabilities to comply with a UE capability policy, in accordance with some embodiments;

FIG. 4 illustrates an example of communicating with a wireless network via a proxy function, in accordance with some embodiments;

FIG. 5 illustrates an example process for applying a UE capability policy in a wireless network, in accordance with some embodiments;

FIGS. 6 and 7 illustrate example environments in which one or more embodiments, described herein, may be implemented;

FIG. 8 illustrates an example arrangement of a radio access network ("RAN"), in accordance with some embodiments; and

FIG. 9 illustrates example components of one or more devices, in accordance with one or more embodiments described herein.

### DETAILED DESCRIPTION OF EXAMPLE EMBODIMENTS

The following detailed description refers to the accompanying drawings. The same reference numbers in different drawings may identify the same or similar elements.

UEs, such as mobile telephones, IoT devices, etc. may have widely varying capabilities or functionalities. Wireless network providers such as mobile network operators ("MNOs") may be able to leverage the capabilities of UEs to provide enhanced services or functionality to UEs. For example, in embodiments described herein, the capability of UEs to implement particular cryptography techniques and/or parameters of such cryptography techniques may be useful in securing communications between UEs and the wireless network. Generally, utilizing "stronger" cryptography techniques (e.g., which are more difficult to attack, "hack," "crack," etc.) may provide for enhanced security as compared to "weaker" cryptography techniques. In practice, some UEs may have the capability to implement stronger cryptography techniques, while other UEs may lack the capability to do so (e.g., due to hardware resource constraints or other factors). Further, in some circumstances, UE capabilities may change over time, such as by receiving updates (e.g., firmware updates, Over-the-Air ("OTA") updates, etc.) that augment the capabilities of UEs. As one example, a UE that does not have the capability to implement a particular cryptography technique (e.g., a particular encryption algorithm) may be updated to implement the particular cryptography technique.

In the context of a wireless network, a wireless network operator may seek to secure access to the wireless network, or to particular portions of the wireless network, based on UE capability information. As one example, the wireless network operator may provide particular network slices that are associated with enhanced security features (e.g., as compared to other network slices such as "public" or "open" network slices), such as implementing relatively strong encryption techniques (e.g., encryption techniques that utilize a relatively high quantity of bits, encryption techniques that are resistant to quantum computing-based attacks, etc.). In accordance with some embodiments, UE capability information, which may be dynamic and ever-changing, may be used as a factor based on which the wireless network determines whether to provide access to a UE (e.g., access to a particular network slice such as a "private" or secure network slice). Further, as discussed below, in situations where a UE does not include or implement capabilities associated with accessing the wireless network, the UE may be updated as part of a network access procedure, thus providing for the UE to access the wireless network while also allowing the network to maintain UE capability-based access policies.

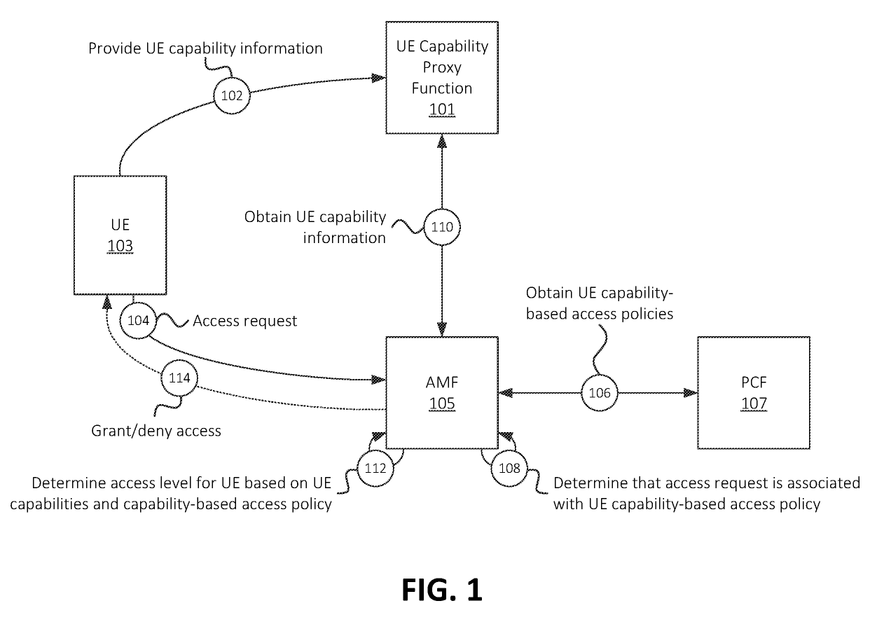

FIG. 1 illustrates an example overview of some embodiments. As shown, UE Capability Proxy Function ("UCPF") 101 may receive (at 102) UE capability information associated with one or more UEs 103. In some embodiments, UCPF 101 may be an element of a wireless network, such as a Network Function ("NF") of the wireless network. In such instances, UE 103 may communicate with UCPF 101 via a gateway, interface, etc. associated with the wireless network such as a Network Exposure Function ("NEF") or a Service Capability Exposure Function ("SCEF"). In some embodiments, UE 103 may implement an application, API, SDK, etc. via which UE 103 communicates (at 102) with UCPF 101 to provide the UE capability information.

In some embodiments, UCPF 101 may be external to the wireless network (e.g., may be implemented by an application server or some other suitable device or system). In such embodiments, UCPF 101 may communicate with elements of the wireless network (e.g., Access and Mobility Management Function ("AMF") 105, a Mobility Management Entity ("MME"), and/or other suitable elements) via a NEF, SCEF, etc. In some embodiments, the functionality described herein with respect to UCPF 101 may be performed by multiple devices or systems, including one or more NFs of the wireless network (e.g., AMF 105, an MME, etc.) and/or one or more devices or systems that are external to the wireless network.

In accordance with some embodiments, the UE capability information may indicate protocols, APIs, libraries, SDKs, applications and/or versions thereof, cryptography configurations, etc. of UE 103. Cryptography configurations may include, for example, particular cryptography techniques such as cryptography algorithms or protocols implemented by UE 103, and/or parameters thereof. For example, a particular cryptography technique may include an Advanced Encryption Standard ("AES") technique which uses 128-bit keys, which may be referred to as "AES-128." As another example, another cryptography technique may include an AES-256 technique. Other examples of cryptography techniques may include Rivest–Shamir–Adleman ("RSA") techniques such as RSA-1024 or RSA-2048, Elliptic-Curve Cryptography ("ECC") techniques such as ECC-256 or ECC-384, a Kyber Key Encapsulation Method ("KEM"), and so on. In some embodiments, the UE capability information may include, or may otherwise indicate, cryptography assets associated with the cryptography techniques implemented by UE 103, such as keys, certificates, tokens, or the like.

In the examples described herein, UE capability information may refer to dynamic aspects of UE 103 that may change or may be updated over time (e.g., APIs, libraries, SDKs, etc. may be updated via OTA update or some other type of update procedure). In practice, similar techniques may apply to one or more static aspects of UE 103, such as hardware capabilities (e.g., screen size, storage space, quantity or types of wireless radios, etc.).

UE 103 may provide (at 102) the UE capability information on an ongoing basis, which may include notifying UCPF 101 when a change or update is made to one or more UE capabilities. As one example, such change or update may include receiving or generating one or more new keys or tokens as part of a cryptographic authentication procedure, updating or installing a library or SDK used for implementing a cryptography technique, or the like. In some embodiments, UE 103 may provide (at 102) UE capability information periodically or intermittently (e.g., every hour, every day, every two weeks, etc.). In some embodiments, UE 103 may provide (at 102) UE capability information on an event-driven basis, such as when UE 103 powers on, when UE 103 attaches to a wireless network, when UE 103 moves to or from a particular location, etc. When providing the UE capability information, UE 103 may provide one or more identifiers of UE 103, such as a Mobile Directory Number ("MDN"), an International Mobile Subscriber Identity ("IMSI") value, an International Mobile Station Equipment Identity ("IMEI") value, a Subscription Permanent Identifier ("SUPI"), a Globally Unique Temporary Identifier ("GUTI"), an Internet Protocol ("IP") address, and/or other one or more other suitable identifiers based on which UE 103 and its corresponding capability information may be uniquely identified.

UE 103 may, for example, include an application, API, etc. that determines the UE capability information. In some embodiments, such information may be provided by or via an operating system, kernel, firmware, application, etc. of UE 103. In this manner, UCPF 101 may serve as a repository that maintains capability information for one or more UEs 103.

As further shown, UE 103 may output (at 104) an access request to the wireless network, such as a request to access (e.g., attach or connect to) a RAN of the wireless network. In some embodiments, the access request may specify a particular requested network slice, a particular set of Quality of Service ("QoS") parameters or Service Level Agreements ("SLAs"), and/or other requested access parameters. In some embodiments, the access request may include one or more identifiers of UE 103, such as an MDN, an IMSI value, an IMEI value, a SUPI, a GUTI, an IP address, and/or other one or more other suitable identifiers based on which UE 103 may be uniquely identified.

AMF 105 may obtain (at 106) UE capability-based access policies from a policy element of the wireless network, such as Policy Control Function ("PCF") 107, a Policy Charging and Rules Function ("PCRF"), and/or some other suitable source. For example, AMF 105 may, after receiving (at 104) the access request, query PCF 107 for access policies associated with UE 103. Additionally, or alternatively, AMF 105 may receive access policies associated with UE 103 (and/or one or more other UEs 103) prior to receiving (at 104) the access request from UE 103. The access policies may be used by AMF 105 to determine whether to grant access to UE 103, and/or to determine parameters under which UE 103 is authorized to access the wireless network, as discussed below.

In accordance with some embodiments, the access policies provided by PCF 107 may include UE capability-based access policies, which may specify particular UE capabilities that are conditions for granting access to UE 103. For example, a particular UE capability-based access policy may specify that access to a particular network slice requires UE implementation of a particular cryptography technique such as an AES-256 encryption technique.

In this example, assume that AMF 105 determines (at 108) that the access request from UE 103 is associated with a particular UE capability-based access policy. For instance, the access request may request access to a particular network slice, and the particular UE capability-based access policy may indicate criteria or conditions relating to UE capabilities, such as the implementation of an AES-256 encryption technique, for access to the particular network slice. As another example, the access request may include a request for access to any or all network slices that UE 103 is authorized to access (e.g., may not specifically identify a particular network slice), and the particular network slice may be indicated by UE information (e.g., as provided by a UE information repository such as a Unified Data Management function ("UDM"), a Unified Data Repository ("UDR"), or a Home Subscriber Server ("HSS")) as a network slice that UE 103 may have access to, potentially subject to other policies maintained by PCF 107.

Based on determining (at 108) that the access request is associated with a UE capability-based access policy (e.g., based on determining that UE capability information should be determined in order to determine whether accept or deny the access request), AMF 105 may obtain (at 110) UE capability information, associated with UE 103, from UCPF 101. For example, AMF 105 may provide an identifier of UE 103 to UCPF 101, and UCPF 101 may respond with up-to-date UE capability information associated with UE 103.

AMF 105 may determine (at 112) an access level for UE 103 based on the UE capability policy (e.g., as provided by PCF 107) as well as the UE capability information (e.g., as provided by UCPF 101). For example, AMF 105 may determine whether UE 103 implements, supports, etc. techniques or capabilities specified in the UE capability policy. For example, continuing with the example presented above, AMF 105 may determine (e.g., based on the UE capability information) whether UE 103 implements an AES-256 cryptography technique.

In situations where the UE capability information indicates that UE 103 satisfies the UE capability policy (e.g., when UE 103 implements the AES-256 cryptography technique), AMF 105 may grant (at 114) access in response to the access request. For example, AMF 105 may facilitate further communications or protocols to grant the requested access, such as by communicating with other elements of the wireless network (e.g., RAN elements and/or core network elements) to establish one or more communication sessions between UE 103 and the wireless network.

In some scenarios, the UE capability information of UE 103 may not satisfy the UE capability policy indicated by PCF 107. In such scenarios, AMF 105 may deny the requested access to the wireless network. Additionally, or alternatively, when indicating access parameters to UE 103, AMF 105 may forgo indicating access that would have been granted if the UE capability information had met the UE capability policy. For example, if the network slice associated with the UE capability policy is a first network slice, AMF 105 may identify that UE 103 is authorized to access a second network slice (e.g., which is not subject to the UE capability policy), and may indicate (at 114) to UE 103 that UE 103 is authorized to access the second network slice.

In some embodiments, the particular network slice identified in the UE capability policy may be associated with multiple different modes or access levels. For example, the UE capability policy may indicate that UEs 103 that do not implement a particular cryptography technique (e.g., AES-256 or some other particular cryptography technique) are permitted to access the particular network slice in a "restricted" or "limited access" mode. In such instances, when responding (at 114) to the access request, AMF 105 may indicate that UE 103 is authorized to access the particular network slice in the "restricted" or "limited access" mode. Further, in some embodiments, AMF 105 may propagate the "restricted" or "limited access" mode, for UE 103, to one or more other network elements such as routers, NFs, or the like. In this sense, both UE 103 as well as the wireless network may be made "aware" that UE 103 has been granted access to the particular network slice in the "restricted" or "limited access" mode. In some implementations, the "restricted" or "limited access" mode may include certain types of services not being available to UE 103, certain routing paths within the wireless network not being permitted or selected for traffic associated with UE 103, content-based restrictions, endpoint-based restrictions (e.g., NFs with which UE 103 is permitted to communicate), firewall or access control list policies, or other types of restrictions or limited access.

In some embodiments, the UE capability policy may include "tiers" of access that are associated with different UE capabilities. For example, the UE capability policy may specify that if a UE includes a first set of capabilities (e.g., implements a first cryptography technique such as AES-256), then such UE is authorized for "full" access to a particular network slice. Further, the UE capability policy may specify that if a UE includes a second set of capabilities (e.g., implements a second cryptography technique such as AES-128), then such UE is authorized for "tier 1 restricted" access to a particular network slice. Additionally, the UE capability policy may specify that if a UE includes a third set of capabilities (e.g., implements a third cryptography technique such as ECC-384), then such UE is authorized for "tier 2 restricted" access to a particular network slice. In the above example, ther "tier 1 restricted" and "tier 2 restricted" modes may include different restrictions, such as different restrictions on types of services provided via the particular network slice of the wireless network, different routing paths within the wireless network, etc. As another example, the UE capability policy may specify a set of UE capabilities for full access to the wireless network, and may specify particular subsets of the set of UE capabilities for which UEs may be granted restricted or tiered access to the wireless network.

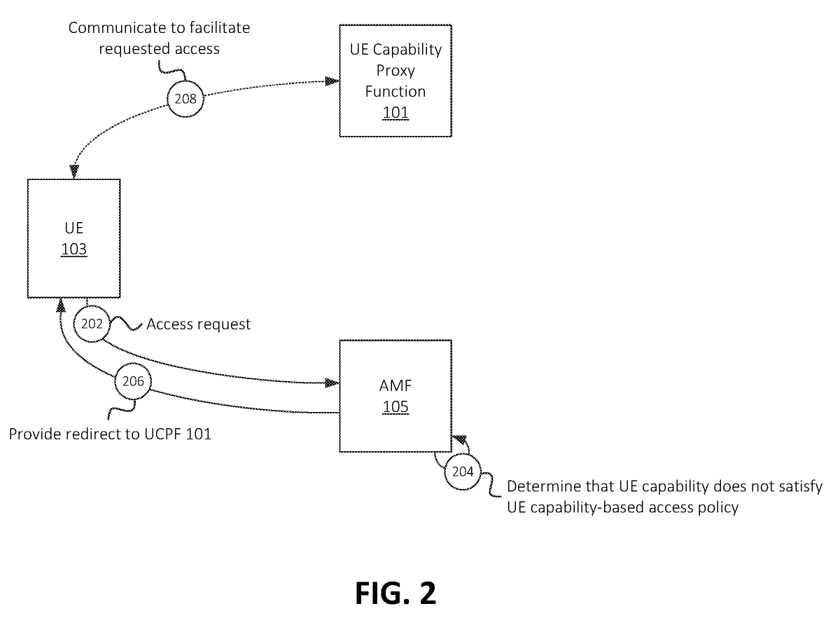

In some embodiments, if the UE capability information associated with UE 103 does not meet criteria specified in the UE capability policy (e.g., criteria associated with a "full" access mode or some other mode), then AMF 105 may notify UE 103 that the access request is denied. For example, as shown in FIG. 2, UE 103 may output (at 202) an access request to the wireless network (e.g., to AMF 105), and AMF 105 may determine (at 204) that UE capability information associated with UE 103 does not satisfy a UE capability policy associated with the request, as discussed above. AMF 105 may accordingly notify UE 103 that the request has been denied.

In some embodiments, when notifying UE 103 that the access request is denied, AMF 105 may provide information indicating a reason or cause for the denial, where such reason or cause includes the UE capability information not meeting criteria specified in the UE capability policy in this example. In some embodiments, AMF 105 may provide (at 206) a redirect instruction, which may include communication information (e.g., an IP address, a hostname, etc.) of UCPF 101, such that UE 103 may further communicate with UCPF 101 to attempt to gain access to the wireless network. Additionally, or alternatively, in some embodiments, the denial indication from AMF 105 may, in some embodiments, not include a redirect instruction and/or may not include communication information of UCPF 101. In such embodiments, UE 103 may be configured to communicate with UCPF 101 when receiving an access denial (e.g., which indicates a reason or cause related to a UE capability policy) and/or redirection instruction from AMF 105. For example, an application, API, etc. implemented by UE 103 may be configured with communication information, discovery information, and/or other suitable information based on which UE 103 may identify and/or communicate with UCPF 101.

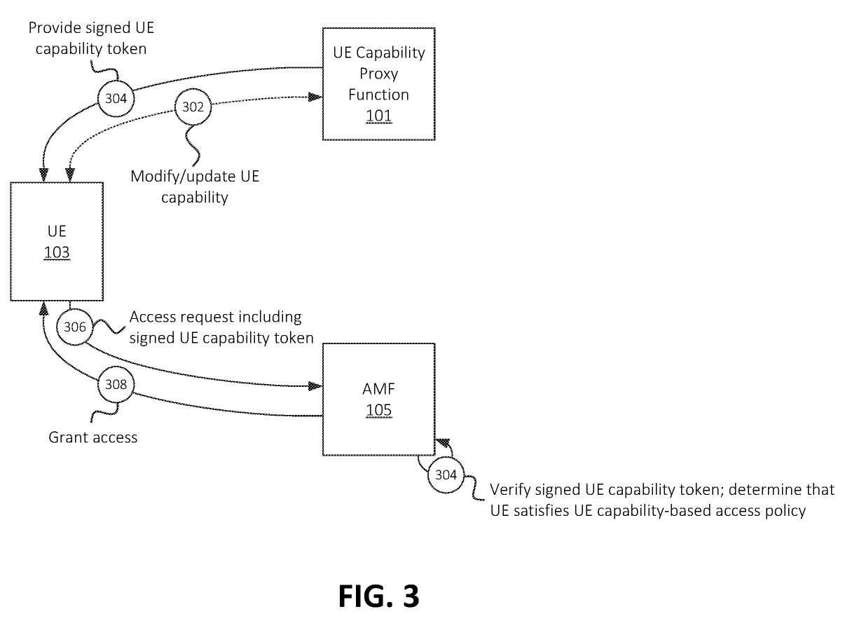

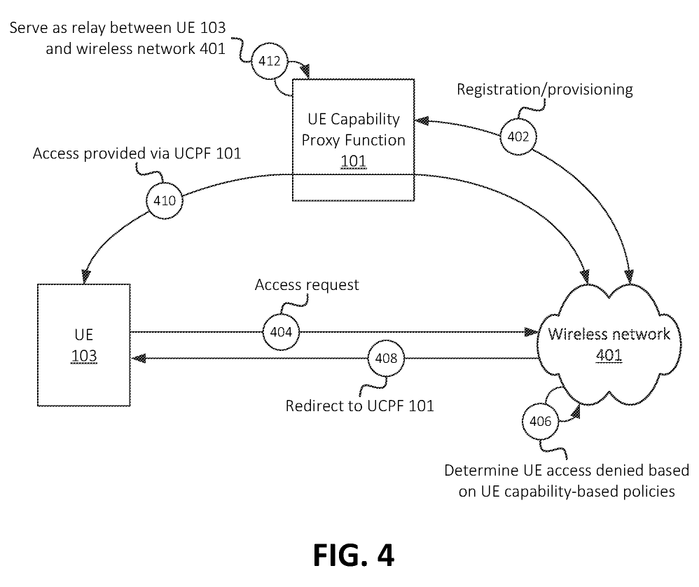

UE 103 may accordingly communicate (at 208) with UCPF 101 to facilitate the requested access to the wireless network. FIGS. 3 and 4 illustrate examples of such communications to facilitate access between UE 103 and the wireless network. For example, as shown in FIG. 3, after receiving (e.g., at 202) a redirect request or access denial notification, UE 103 may communicate (at 302) with UCPF 101 to modify and/or update UE capabilities. For example, UE 103 may forward information indicating a cause or reason (e.g., as indicated by AMF 105) for a denial of access to the wireless network. Such cause or reason may include, for example, information indicating one or more UE capability policies that are not met by UE 103. UCPF 101 may identify (e.g., based on UE capability information provided at 102), for example, that UE 103 does not implement a particular cryptography technique specified in or associated with the UE capability policy, does not have updated versions of libraries or APIs, does not possess current or valid keys or certificates, etc.

Accordingly, UCPF 101 may provide updated or valid libraries, APIs, SDKs, certificates, keys, etc. that meet the criteria specified in the UE capability policies. Additionally, or alternatively, UCPF 101 may provide a most up-to-date set of libraries, APIs, SDKs, certificates, keys, etc. (e.g., independently of criteria specified in the UE capability policies).

In some embodiments, UCPF 101 may modify or update (at 302) UE capabilities irrespective of receiving a request for such update from UE 103. For example, in some scenarios, UCPF 101 may receive updates to APIs, SDKs, certificates, etc. maintained by UE 103. UCPF 101 may identify that such updates are applicable to UE 103, based on identifying that such updates pertain to APIs, SDKs, certificates, etc. indicated in UE capability information associated with UE 103 (e.g., may include updated version numbers or may otherwise be associated with such APIs, SDKs, etc.). In such scenarios, UCPF 101 may automatically provide (e.g., "push") the updates to UE 103, and may maintain UE capability information indicating the updates to UE 103. In some embodiments, UE 103 may request (e.g., "pull") updates from UCPF 101 and/or some other source on a periodic basis or on some other ongoing basis.

Once UE capability information of UE 103 has been updated (at 302), UCPF 101 may provide (at 304) a signed UE capability token to UE 103, signifying that UE capability information of UE 103 has been verified by UCPF 101. The UE capability token may, for example, have been signed using a private key associated with UCPF 101, thus verifying the source of the UE capability token. The UE capability token may include a version number or other identifier, such that the UE capability token may itself be used to identify particular capabilities (e.g., cryptography configurations, APIs, SDKs, libraries, certificates, etc.) implemented by UE 103.

UE 103 may use (at 306) the signed token as part of an access request to the wireless network. For example, UE 103 may output (at 306) an access request to AMF 105, and may include the UE capability token with the access request. AMF 105 may verify (at 304) the UE capability token, such as by using a public key associated with UCPF 101 (e.g., where UCPF 101 uses a private key of an asymmetric key pair, that includes the public key, to generate the signed UE capability token).

AMF 105 may further identify UE capability information based on the UE capability token. For example, as noted above, in some embodiments, the UE capability token may include identifiers or other indicators of the UE capability information. Additionally, or alternatively, AMF 105 may communicate with UCPF 101 (e.g., using the UE capability token and/or an identifier of UE 103) to identify UE capability information of UE 103. In this example, assume that AMF 105 has verified (at 304) that the UE capability information of UE 103 satisfies criteria, conditions, etc. of an applicable UE capability policy. Accordingly, AMF 105 may grant (at 308) network access to UE 103.

As noted above, granting such access may include continuing with or otherwise facilitating a connection establishment procedure between UE 103 and the wireless network. Such procedures may include, for example, an attachment procedure between UE 103 and a RAN of the wireless network, and/or the establishment of one or more communication sessions (e.g., protocol data unit ("PDU") sessions) between UE 103 and a core of the wireless network. As also noted above, the granted access may be a tiered, limited, restricted, etc. mode of access in situations where some but not all conditions of a UE capability policy are met by the UE capability information.

In some embodiments, UCPF 101 may act as a communication proxy between UE 103 and the wireless network, such as in instances where UE 103 cannot or otherwise does not satisfy UE capability policies associated with the wireless network. For example, as shown in FIG. 4, UCPF 101 and wireless network 401 may perform (at 402) a registration and/or provisioning procedure. For example, wireless network 401 may register UCPF 101 with one or more network identifiers, such as a SUPI, a GUTI, etc., which UCPF 101 may use to access wireless network 401. For example, in some embodiments, UCPF 101 may connect to a RAN of wireless network 401 and may communicate with wireless network 401 wirelessly. As another example, in some embodiments, UCPF 101 may be connected to wireless network 401 via a wired backhaul connection or some other suitable type of communication pathway. As noted above, in some embodiments, some or all of the functionality of UCPF 101 may be implemented by one or more devices or systems that are external to wireless network 401. For example, in the example of FIG. 4, some or all of the operations described with respect to UCPF 101 may be performed by a gateway, customer premises equipment, another UE, etc. that is communicatively coupled to UE 103.

In some embodiments, as part of the registration and/or provisioning procedure (at 402), UCPF 101 may install, instantiate, implement, etc. UE capabilities that satisfy one or more UE capability policies of wireless network 401. For example, UCPF 101 may maintain up-to-date libraries, cryptography algorithms, SDKs, APIs, etc.

As similarly discussed above, UE 103 may output (at 404) an access request to wireless network 401 (e.g., to AMF 105), and wireless network 401 may determine (at 406) that access is denied based on UE capabilities of UE 103 (e.g., UE 103 does not implement cryptography techniques specified by UE capability policies associated with wireless network 401 and/or otherwise does not comply with or satisfy one or more UE capability policies). For example, wireless network 401 may determine that UE 103 does not satisfy the UE capability policies based on a UE capability token provided by UE 103 (e.g., the UE capability token may indicate outdated UE capability information such as APIs, SDKs, etc. and/or may lack certain UE capability information), and/or based on communicating with UCPF 101 to identify UE capability information of UE 103.

Wireless network 401 may accordingly deny (at 408) access to UE 103, which may include providing a redirect instruction to communicate with UCPF 101. For example, wireless network 401 may identify that the UE capability policy has been provided by or is otherwise associated with UCPF 101, and wireless network 401 may accordingly indicate (at 408) an identifier of UCPF 101 to UE 103.

In some embodiments, wireless network 401 may authenticate and/or verify general authorization of UE 103 to access wireless network 401 (e.g., other than allowing access to a particular slice such as a secure slice for which UE capability policies are in place). For example, wireless network 401 may verify that UE 103 has previously been registered, provisioned, etc. with wireless network 401, even though UE 103 may not have access to particular network slices of wireless network 401 in accordance with one or more UE capability policies (e.g., UE capability information of UE 103 may indicate that UE 103 does not have one or more capabilities required or specified by such UE capability policies). Wireless network 401 may provide (at 408) a signed wireless network access token, signifying that UE 103 is authenticated and/or generally or conditionally authorized to access wireless network 401. The wireless network access token may be signed, for example, using a private key maintained by wireless network 401, and/or may otherwise include a secure indication that such token has been generated or provided by wireless network 401.

UE 103 may accordingly communicate (at 410) with UCPF 101 based on the access denial and/or redirect instruction provided (at 408) by wireless network 401. UE 103 may communicate with UCPF 101 via a wired or wireless interface. For example, UCPF 101 may implement a Wi-Fi network to which UE 103 is communicatively coupled. In some embodiments, UCPF 101 may be a "dual mode" device that is able to simultaneously communicate with wireless network 401 (e.g., via a licensed radio access technology ("RAT") such as a Fifth Generation ("5G") RAT or a Long-Term Evolution ("LTE") RAT) and with UE 103 (e.g., via an unlicensed RAT such as a Wi-Fi RAT).

When communicating (at 410) with UCPF 101, UE 103 may indicate a cause or reason for access denial by wireless network 401. In some embodiments, UE 103 may provide a wireless network access token provided by wireless network 401. The wireless network access token may signify, to UCPF 101, that UE 103 is generally authorized to access wireless network 401. As noted above, the "general" authorization for UE 103 may be exclusive of particular access parameters, such as access to a particular network slice of wireless network 401. The "general" authorization for UE 103 may, for example, include authorization to access other network slices of wireless network 401, such as a public slice and/or some other network slice that is not secured by a UE capability policy. In this manner, UCPF 101 may be able to verify that UE 103 is authorized to access wireless network 401 via UCPF 101, and may deny access to UEs that are unable to provide such verification.

UCPF 101 may serve (at 412) as a relay for communications between UE 103 and wireless network 401. For example, once UCPF 101 has verified that UE 103 is authorized to access wireless network 401, UCPF 101 may establish one or more communication sessions (e.g., radio bearers, PDU sessions, etc.) between UCPF 101 and wireless network 401. Such communication sessions may satisfy one or more UE capability policies enforced by wireless network 401, including UE capability policies that were not met by UE 103 (as determined at 406). UCPF 101 may forward communications received, via such communication sessions, to UE 103. Similarly, UCPF 101 may forward communications received from UE 103 to wireless network 401 via the communication session(s) between UCPF 101 and wireless network 401. In this sense, wireless network 401 may maintain its UE capability policies, while also allowing for communications with UEs that are unable or otherwise do not implement capabilities that satisfy the UE capability policies.

While examples are described above in the context of access to a wireless network (e.g., as controlled by AMF 105 or an MME), similar concepts may apply to any type of authorization request that is handled by some other suitable authorization and/or authentication function of wireless network 401. For example, similar concepts may apply to authorization and/or authentication requests received by an Authentication Server Function ("AUSF"), an Authentication, Authorization, Accounting ("AAA"), and/or some other suitable element of wireless network 401.

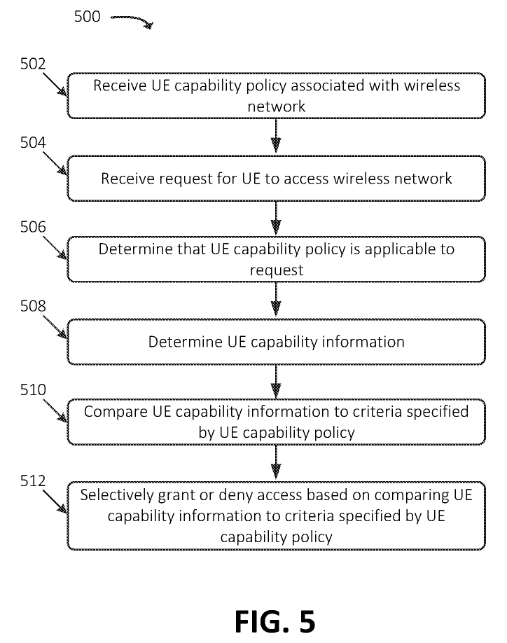

FIG. 5 illustrates an example process 500 for applying a UE capability policy in a wireless network. In some embodiments, some or all of process 500 may be performed by an element of the wireless network that verifies authorization and/or provides access to the wireless network, such as AMF 105. In some embodiments, one or more other devices may perform some or all of process 500 in concert with and/or in lieu of AMF 105, such as UCPF 101.

As shown, process 500 may include receiving (at 502) a UE capability policy associated with a wireless network. For example, as discussed above, AMF 105 may receive one or more UE capability policies, such as from PCF 107. The UE capability policies may include criteria specifying when the UE capability policies are applicable, such as including identifiers of particular UEs, groups of UEs, types of UEs, etc. The criteria specifying when the UE capability policies are applicable may further specify particular network slices, QoS thresholds, and/or other parameters of requests for access that may be received by AMF 105.

The UE capability policies may include conditions, criteria, etc. specifying whether UEs should be granted access to the wireless network. As discussed above, the UE capability policies may further include conditions, criteria, etc. specifying different levels of access to the wireless network based on UE capability information of UEs that request such access. In some example implementations, the UE capability policies may specify particular cryptography configurations, APIs or versions thereof, SDKs or versions thereof, certificates, keys, etc. that are required to be maintained, implemented, supported, and/or otherwise associated with UEs in order for such UEs to be granted access to the wireless network.

Process 500 may further include receiving (at 504) a request for a UE to access the wireless network. For example, a particular UE 103 may output a request to AMF 105 to access the wireless network. In some embodiments, the request may include a request to access a particular network slice of the wireless network. In some embodiments, the request may be received prior to AMF 105 receiving the UE capability policies (e.g., AMF 105 may obtain the UE capability policies based on receiving the access request). In some embodiments, the request for access and the receiving (at 502) of the UE capability policies may be performed independently and/or asynchronously.

Process 500 may additionally include determining (at 506) that the UE capability policy is applicable to the request. For example, AMF 105 may identify whether an identifier of UE 103 meets UE identifiers specified in the UE capability policy (e.g., where different UE capability policies may be applicable to different UEs or groups of UEs). As another example, UCPF 101 may identify whether a requested network slice is a network slice specified in the UE capability policy.

Process 500 may also include determining (at 508) UE capability information associated with the UE. For example, AMF 105 may obtain or receive, from UCPF 101, UE capability information for UE 103. As discussed above, UCPF 101 may communicate with UE 103 (e.g., on an ongoing basis) in order to maintain up-to-date UE capability information of UE 103, which may include cryptography configurations of UE 103 (e.g., cryptography algorithms supported or implemented by UE 103, bit lengths of keys used in encryption and/or decryption techniques by UE 103, etc.).

Process 500 may further include comparing (at 510) the UE capability information to criteria specified by the UE capability policy. For example, AMF 105 may determine whether the UE capability information of UE 103 matches, meets, etc. the criteria specified in the UE capability policy. As one example, if the UE capability policy specifies that UEs are required to implement AES-256 encryption (e.g., an AES cryptography algorithm with a 256-bit long key) in order to access a particular network slice, and if the UE capability information indicates that UE 103 implements AES-256 encryption, then AMF 105 may determine that the UE capability policy is met with respect to UE 103.

Process 500 may additionally include selectively granting or denying (at 512) access to the UE based on comparing the UE capability information to the criteria specified by the UE capability policy. For example, as discussed above, AMF 105 may grant access to UE 103, which may include proceeding with one or more connection establishment procedures, when determining that the UE capability information meets the criteria specified in the UE capability policy. As discussed above, in situations where the UE capability information does not meet some or all of the criteria specified in the UE capability policy, AMF 105 may provide a redirect or other type of response to UE 103, based on which UE 103 may implement alternate techniques to attempt to access the wireless network. As discussed above, such alternate techniques may include communicating with UCPF 101 to update cryptography configurations or other capabilities of UE 103, in order to meet the UE capability policy that was not met. Additionally, or alternatively, UCPF 101 may serve as a relay for communications between UE 103 and the wireless network, where UCPF 101 complies with the UE capability policy.

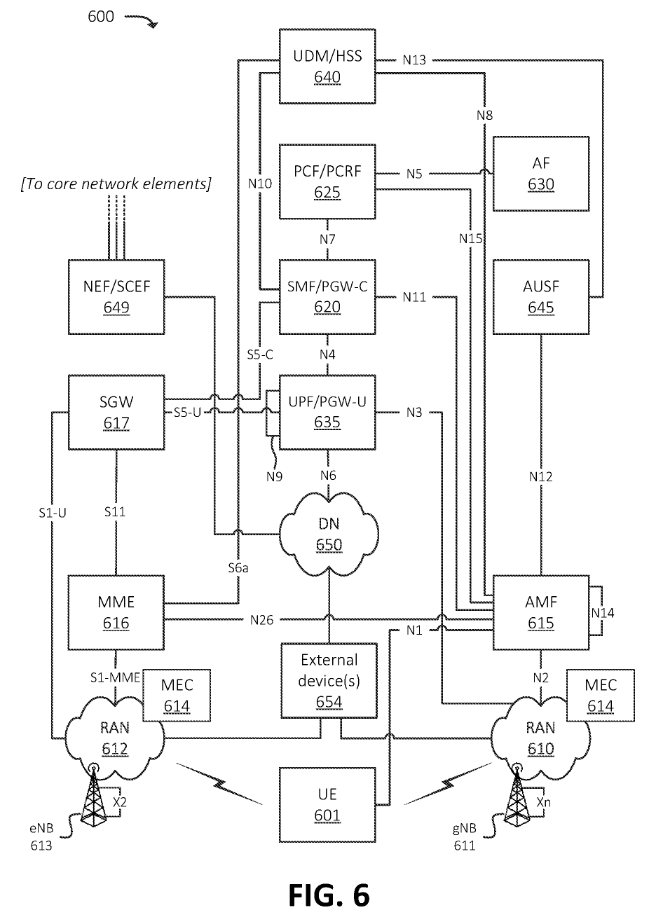

FIG. 6 illustrates an example environment 600, in which one or more embodiments may be implemented. In some embodiments, environment 600 may correspond to a 5G network, and/or may include elements of a 5G network. In some embodiments, environment 600 may correspond to a 5G Non-Standalone ("NSA") architecture, in which a 5G RAT may be used in conjunction with one or more other RATs (e.g., an LTE RAT), and/or in which elements of a 5G core network may be implemented by, may be communicatively coupled with, and/or may include elements of another type of core network (e.g., an evolved packet core ("EPC")). In some embodiments, portions of environment 600 may represent or may include a 5G core ("5GC"). As shown, environment 600 may include UE 601, RAN 610 (which may include one or more Next Generation Node Bs ("gNBs") 611), RAN 612 (which may include one or more evolved Node Bs ("eNBs") 613), and various network functions such as AMF 615, MME 616, Serving Gateway ("SGW") 617, Session Management Function ("SMF")/Packet Data Network ("PDN") Gateway ("PGW")-Control plane function ("PGW-C") 620, PCF/PCRF 625, Application Function ("AF") 630, User Plane Function ("UPF")/PGW-User plane function ("PGW-U") 635, UDM/HSS 640, AUSF 645, and NEF/SCEF 649. Environment 600 may also include one or more networks, such as Data Network ("DN") 650. Environment 600 may include one or more additional devices or systems communicatively coupled to one or more networks (e.g., DN 650), such as one or more external devices 654.

The example shown in FIG. 6 illustrates one instance of each network component or function (e.g., one instance of SMF/PGW-C 620, PCF/PCRF 625, UPF/PGW-U 635, UDM/HSS 640, and/or AUSF 645). In practice, environment 600 may include multiple instances of such components or functions. For example, in some embodiments, environment 600 may include multiple "slices" of a core network, where each slice includes a discrete and/or logical set of network functions (e.g., one slice may include a first instance of AMF 615, SMF/PGW-C 620, PCF/PCRF 625, and/or UPF/PGW-U 635, while another slice may include a second instance of AMF 615, SMF/PGW-C 620, PCF/PCRF 625, and/or UPF/PGW-U 635). The different slices may provide differentiated levels of service, such as service in accordance with different Quality of Service ("QoS") parameters.

The quantity of devices and/or networks, illustrated in FIG. 6, is provided for explanatory purposes only. In practice, environment 600 may include additional devices and/or networks, fewer devices and/or networks, different devices and/or networks, or differently arranged devices and/or networks than illustrated in FIG. 6. For example, while not shown, environment 600 may include devices that facilitate or enable communication between various components shown in environment 600, such as routers, modems, gateways, switches, hubs, etc. In some implementations, one or more devices of environment 600 may be physically integrated in, and/or may be physically attached to, one or more other devices of environment 600. Alternatively, or additionally, one or more of the devices of environment 600 may perform one or more network functions described as being performed by another one or more of the devices of environment 600.

Additionally, one or more elements of environment 600 may be implemented in a virtualized and/or containerized manner. For example, one or more of the elements of environment 600 may be implemented by one or more Virtualized Network Functions ("VNFs"), Cloud-Native Network Functions ("CNFs"), etc. In such embodiments, environment 600 may include, may implement, and/or may be communicatively coupled to an orchestration platform that provisions hardware resources, installs containers or applications, performs load balancing, and/or otherwise manages the deployment of such elements of environment 600. In some embodiments, such orchestration and/or management of such elements of environment 600 may be performed by, or in conjunction with, the open-source Kubernetes^{®} application programming interface ("API") or some other suitable virtualization, containerization, and/or orchestration system.

Elements of environment 600 may interconnect with each other and/or other devices via wired connections, wireless connections, or a combination of wired and wireless connections. Examples of interfaces or communication pathways between the elements of environment 600, as shown in FIG. 6, may include an N1 interface, an N2 interface, an N3 interface, an N4 interface, an N5 interface, an N6 interface, an N7 interface, an N8 interface, an N9 interface, an N10 interface, an N11 interface, an N12 interface, an N13 interface, an N14 interface, an N15 interface, an N26 interface, an S1-C interface, an S1-U interface, an S5-C interface, an S5-U interface, an S6a interface, an S11 interface, and/or one or more other interfaces. Such interfaces may include interfaces not explicitly shown in FIG. 6, such as Service-Based Interfaces ("SBIs"), including an Namf interface, an Nudm interface, an Npcf interface, an Nupf interface, an Nnef interface, an Nsmf interface, and/or one or more other SBIs. In some embodiments, environment 600 may be, may include, may be implemented by, and/or may be communicatively coupled to wireless network 401.

UE 601 may include a computation and communication device, such as a wireless mobile communication device that is capable of communicating with RAN 610, RAN 612, and/or DN 650. UE 601 may be, or may include, a radiotelephone, a personal communications system ("PCS") terminal (e.g., a device that combines a cellular radiotelephone with data processing and data communications capabilities), a personal digital assistant ("PDA") (e.g., a device that may include a radiotelephone, a pager, Internet/intranet access, etc.), a smart phone, a laptop computer, a tablet computer, a camera, a personal gaming system, an Internet of Things ("IoT") device (e.g., a sensor, a smart home appliance, a wearable device, a programmable logic controller or other industrial controller, a Machine-to-Machine ("M2M") device, or the like), a Fixed Wireless Access ("FWA") device, or another type of mobile computation and communication device. UE 601 may send traffic to and/or receive traffic (e.g., user plane traffic) from DN 650 via RAN 610, RAN 612, and/or UPF/PGW-U 635. In some embodiments, UE 601 may include and/or may implement some or all of the functionality discussed above with respect to UE 103 and/or UCPF 101.

RAN 610 may be, or may include, a 5G RAN that implements a 5G RAT and that includes one or more base stations (e.g., one or more gNBs 611), via which UE 601 may communicate with one or more other elements of environment 600. UE 601 may communicate with RAN 610 via an air interface (e.g., as provided by gNB 611). For instance, RAN 610 may receive traffic (e.g., user plane traffic such as voice call traffic, data traffic, messaging traffic, etc.) from UE 601 via the air interface, and may communicate the traffic to UPF/PGW-U 635 and/or one or more other devices or networks. Further, RAN 610 may receive signaling traffic, control plane traffic, etc. from UE 601 via the air interface, and may communicate such signaling traffic, control plane traffic, etc. to AMF 615 and/or one or more other devices or networks. Additionally, RAN 610 may receive traffic intended for UE 601 (e.g., from UPF/PGW-U 635, AMF 615, and/or one or more other devices or networks) and may communicate the traffic to UE 601 via the air interface.

RAN 612 may be, or may include, an LTE RAN that implements an LTE RAT and that includes one or more base stations (e.g., one or more eNBs 613), via which UE 601 may communicate with one or more other elements of environment 600. UE 601 may communicate with RAN 612 via an air interface (e.g., as provided by eNB 613). For instance, RAN 612 may receive traffic (e.g., user plane traffic such as voice call traffic, data traffic, messaging traffic, signaling traffic, etc.) from UE 601 via the air interface, and may communicate the traffic to UPF/PGW-U 635 (e.g., via SGW 617) and/or one or more other devices or networks. Further, RAN 612 may receive signaling traffic, control plane traffic, etc. from UE 601 via the air interface, and may communicate such signaling traffic, control plane traffic, etc. to MME 616 and/or one or more other devices or networks. Additionally, RAN 612 may receive traffic intended for UE 601 (e.g., from UPF/PGW-U 635, MME 616, SGW 617, and/or one or more other devices or networks) and may communicate the traffic to UE 601 via the air interface.

One or more RANs of environment 600 (e.g., RAN 610 and/or RAN 612) may include, may implement, and/or may otherwise be communicatively coupled to one or more edge computing devices, such as one or more Multi-Access/Mobile Edge Computing ("MEC") devices (referred to sometimes herein simply as a "MECs") 614. MECs 614 may be co-located with wireless network infrastructure equipment of RANs 610 and/or 612 (e.g., one or more gNBs 611 and/or one or more eNBs 613, respectively). Additionally, or alternatively, MECs 614 may otherwise be associated with geographical regions (e.g., coverage areas) of wireless network infrastructure equipment of RANs 610 and/or 612. In some embodiments, one or more MECs 614 may be implemented by the same set of hardware resources, the same set of devices, etc. that implement wireless network infrastructure equipment of RANs 610 and/or 612. In some embodiments, one or more MECs 614 may be implemented by different hardware resources, a different set of devices, etc. from hardware resources or devices that implement wireless network infrastructure equipment of RANs 610 and/or 612. In some embodiments, MECs 614 may be communicatively coupled to wireless network infrastructure equipment of RANs 610 and/or 612 (e.g., via a high-speed and/or low-latency link such as a physical wired interface, a high-speed and/or low-latency wireless interface, or some other suitable communication pathway).

MECs 614 may include hardware resources (e.g., configurable or provisionable hardware resources) that may be configured to provide services and/or otherwise process traffic to and/or from UE 601, via RAN 610 and/or 612. For example, RAN 610 and/or 612 may route some traffic from UE 601 (e.g., traffic associated with one or more particular services, applications, application types, etc.) to a respective MEC 614 instead of to core network elements of 600 (e.g., UPF/PGW-U 635). MEC 614 may accordingly provide services to UE 601 by processing such traffic, performing one or more computations based on the received traffic, and providing traffic to UE 601 via RAN 610 and/or 612. MEC 614 may include, and/or may implement, some or all of the functionality described above with respect to UPF/PGW-U 635, AF 630, one or more application servers, and/or one or more other devices, systems, VNFs, CNFs, etc. In this manner, ultra-low latency services may be provided to UE 601, as traffic does not need to traverse links (e.g., backhaul links) between RAN 610 and/or 612 and the core network.

AMF 615 may include one or more devices, systems, VNFs, CNFs, etc., that perform operations to register UE 601 with the 5G network, to establish bearer channels associated with a session with UE 601, to hand off UE 601 from the 5G network to another network, to hand off UE 601 from the other network to the 5G network, manage mobility of UE 601 between RANs 610 and/or gNBs 611, and/or to perform other operations. In some embodiments, the 5G network may include multiple AMFs 615, which communicate with each other via the N14 interface (denoted in FIG. 6 by the line marked "N14" originating and terminating at AMF 615). As discussed above, in some embodiments, AMF 615 may include or may implement some or all of the functionality of UCPF 101. Additionally, or alternatively, in some embodiments, AMF 615 may communicate with UCPF 101 in order to facilitate access control mechanisms with respect to the wireless network (e.g., based on UE capability policies associated with the wireless network).

MME 616 may include one or more devices, systems, VNFs, CNFs, etc., that perform operations to register UE 601 with the EPC, to establish bearer channels associated with a session with UE 601, to hand off UE 601 from the EPC to another network, to hand off UE 601 from another network to the EPC, manage mobility of UE 601 between RANs 612 and/or eNBs 613, and/or to perform other operations. As discussed above, in some embodiments, MME 616 may include or may implement some or all of the functionality of UCPF 101. Additionally, or alternatively, in some embodiments, MME 616 may communicate with UCPF 101 in order to facilitate access control mechanisms with respect to the wireless network (e.g., based on UE capability policies associated with the wireless network).

SGW 617 may include one or more devices, systems, VNFs, CNFs, etc., that aggregate traffic received from one or more eNBs 613 and send the aggregated traffic to an external network or device via UPF/PGW-U 635. Additionally, SGW 617 may aggregate traffic received from one or more UPF/PGW-Us 635 and may send the aggregated traffic to one or more eNBs 613. SGW 617 may operate as an anchor for the user plane during inter-eNB handovers and as an anchor for mobility between different telecommunication networks or RANs (e.g., RANs 610 and 612).

SMF/PGW-C 620 may include one or more devices, systems, VNFs, CNFs, etc., that gather, process, store, and/or provide information in a manner described herein. SMF/PGW-C 620 may, for example, facilitate the establishment of communication sessions on behalf of UE 601. In some embodiments, the establishment of communications sessions may be performed in accordance with one or more policies provided by PCF/PCRF 625.

PCF/PCRF 625 may include one or more devices, systems, VNFs, CNFs, etc., that aggregate information to and from the 5G network and/or other sources. PCF/PCRF 625 may receive information regarding policies and/or subscriptions from one or more sources, such as subscriber databases and/or from one or more users (such as, for example, an administrator associated with PCF/PCRF 625). As discussed above, such policies may include UE capability policies, based on which access or authorization may be selectively granted or denied to one or more UEs 601 by elements of the wireless network based on whether such UEs 601 comply with such UE capability policies.

AF 630 may include one or more devices, systems, VNFs, CNFs, etc., that receive, store, and/or provide information that may be used in determining parameters (e.g., quality of service parameters, charging parameters, or the like) for certain applications.

UPF/PGW-U 635 may include one or more devices, systems, VNFs, CNFs, etc., that receive, store, and/or provide data (e.g., user plane data). For example, UPF/PGW-U 635 may receive user plane data (e.g., voice call traffic, data traffic, etc.), destined for UE 601, from DN 650, and may forward the user plane data toward UE 601 (e.g., via RAN 610, SMF/PGW-C 620, and/or one or more other devices). In some embodiments, multiple instances of UPF/PGW-U 635 may be deployed (e.g., in different geographical locations), and the delivery of content to UE 601 may be coordinated via the N9 interface (e.g., as denoted in FIG. 6 by the line marked "N9" originating and terminating at UPF/PGW-U 635). Similarly, UPF/PGW-U 635 may receive traffic from UE 601 (e.g., via RAN 610, RAN 612, SMF/PGW-C 620, and/or one or more other devices), and may forward the traffic toward DN 650. In some embodiments, UPF/PGW-U 635 may communicate (e.g., via the N4 interface) with SMF/PGW-C 620, regarding user plane data processed by UPF/PGW-U 635.

UDM/HSS 640 and AUSF 645 may include one or more devices, systems, VNFs, CNFs, etc., that manage, update, and/or store, in one or more memory devices associated with AUSF 645 and/or UDM/HSS 640, profile information associated with a subscriber. In some embodiments, UDM/HSS 640 may include, may implement, may be communicatively coupled to, and/or may otherwise be associated with some other type of repository or database, such as a Unified Data Repository ("UDR"). AUSF 645 and/or UDM/HSS 640 may perform authentication, authorization, and/or accounting operations associated with one or more UEs 601 and/or one or more communication sessions associated with one or more UEs 601.

DN 650 may include one or more wired and/or wireless networks. For example, DN 650 may include an Internet Protocol ("IP")-based PDN, a wide area network ("WAN") such as the Internet, a private enterprise network, and/or one or more other networks. UE 601 may communicate, through DN 650, with data servers, other UEs 601, and/or to other servers or applications that are coupled to DN 650. DN 650 may be connected to one or more other networks, such as a public switched telephone network ("PSTN"), a public land mobile network ("PLMN"), and/or another network. DN 650 may be connected to one or more devices, such as content providers, applications, web servers, and/or other devices, with which UE 601 may communicate.

External devices 654 may include one or more devices or systems that communicate with UE 601 via DN 650 and one or more elements of 600 (e.g., via UPF/PGW-U 635). In some embodiments, external devices 654 may include, may implement, and/or may otherwise be associated with UCPF 101. External devices 654 may include, for example, one or more application servers, content provider systems, web servers, or the like. External devices 654 may, for example, implement "server-side" applications that communicate with "client-side" applications executed by UE 601. External devices 654 may provide services to UE 601 such as gaming services, videoconferencing services, messaging services, email services, web services, and/or other types of services.

In some embodiments, external devices 654 may communicate with one or more elements of environment 600 (e.g., core network elements) via NEF/SCEF 649. NEF/SCEF 649 include one or more devices, systems, VNFs, CNFs, etc. that provide access to information, APIs, and/or other operations or mechanisms of one or more core network elements to devices or systems that are external to the core network (e.g., to external device 654 via DN 650). NEF/SCEF 649 may maintain authorization and/or authentication information associated with such external devices or systems, such that NEF/SCEF 649 is able to provide information, that is authorized to be provided, to the external devices or systems. For example, a given external device 654 may request particular information associated with one or more core network elements. NEF/SCEF 649 may authenticate the request and/or otherwise verify that external device 654 is authorized to receive the information, and may request, obtain, or otherwise receive the information from the one or more core network elements. In some embodiments, NEF/SCEF 649 may include, may implement, may be implemented by, may be communicatively coupled to, and/or may otherwise be associated with a Security Edge Protection Proxy ("SEPP"), which may perform some or all of the functions discussed above. External device 654 may, in some situations, subscribe to particular types of requested information provided by the one or more core network elements, and the one or more core network elements may provide (e.g., "push") the requested information to NEF/SCEF 649 (e.g., in a periodic or otherwise ongoing basis).

In some embodiments, external devices 654 may communicate with one or more elements of RAN 610 and/or 612 via an API or other suitable interface. For example, a given external device 654 may provide instructions, requests, etc. to RAN 610 and/or 612 to provide one or more services via one or more respective MECs 614. In some embodiments, such instructions, requests, etc. may include QoS parameters, Service Level Agreements ("SLAs"), etc. (e.g., maximum latency thresholds, minimum throughput thresholds, etc.) associated with the services.

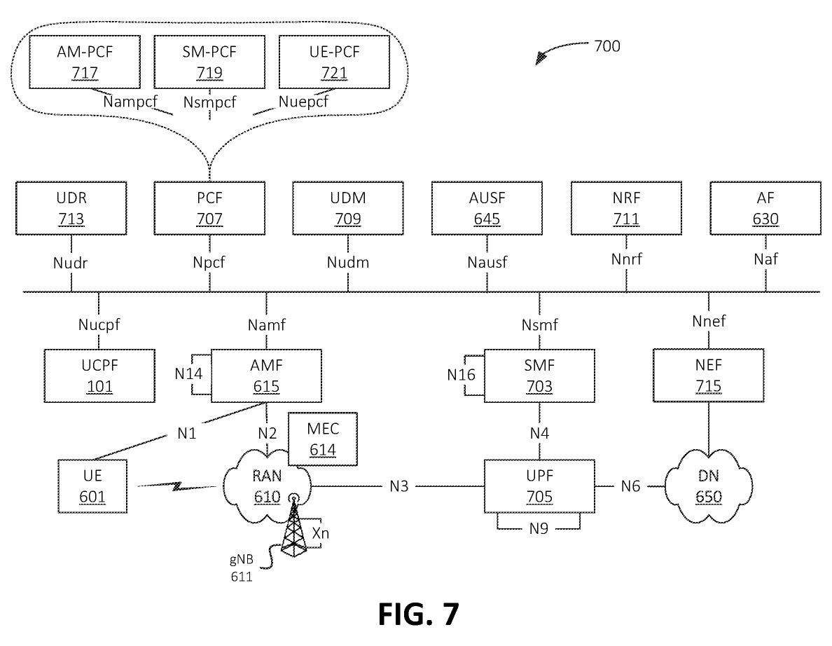

FIG. 7 illustrates another example environment 700, in which one or more embodiments may be implemented. In some embodiments, environment 700 may correspond to a 5G network, and/or may include elements of a 5G network. In some embodiments, environment 700 may correspond to a 5G SA architecture. In some embodiments, environment 700 may include a 5GC, in which 5GC network elements perform one or more operations described herein.

As shown, environment 700 may include UE 601, RAN 610 (which may include one or more gNBs 611 or other types of wireless network infrastructure) and various network functions, which may be implemented as VNFs, CNFs, etc. Such network functions may include AMF 615, SMF 703, UPF 705, PCF 707, UDM 709, AUSF 645, Network Repository Function ("NRF") 711, AF 630, UDR 713, and NEF 715. Environment 700 may also include or may be communicatively coupled to one or more networks, such as DN 650.

The example shown in FIG. 7 illustrates one instance of each network component or function (e.g., one instance of SMF 703, UPF 705, PCF 707, UDM 709, AUSF 645, etc.). In practice, environment 700 may include multiple instances of such components or functions. For example, in some embodiments, environment 700 may include multiple "slices" of a core network, where each slice includes a discrete and/or logical set of network functions (e.g., one slice may include a first instance of SMF 703, PCF 707, UPF 705, etc., while another slice may include a second instance of SMF 703, PCF 707, UPF 705, etc.). Additionally, or alternatively, one or more of the network functions of environment 700 may implement multiple network slices. The different slices may provide differentiated levels of service, such as service in accordance with different QoS parameters.

The quantity of devices and/or networks, illustrated in FIG. 7, is provided for explanatory purposes only. In practice, environment 700 may include additional devices and/or networks, fewer devices and/or networks, different devices and/or networks, or differently arranged devices and/or networks than illustrated in FIG. 7. For example, while not shown, environment 700 may include devices that facilitate or enable communication between various components shown in environment 700, such as routers, modems, gateways, switches, hubs, etc. In some implementations, one or more devices of environment 700 may be physically integrated in, and/or may be physically attached to, one or more other devices of environment 700. Alternatively, or additionally, one or more of the devices of environment 700 may perform one or more network functions described as being performed by another one or more of the devices of environment 700.

Elements of environment 700 may interconnect with each other and/or other devices via wired connections, wireless connections, or a combination of wired and wireless connections. Examples of interfaces or communication pathways between the elements of environment 700, as shown in FIG. 7, may include interfaces shown in FIG. 7 and/or one or more interfaces not explicitly shown in FIG. 7. These interfaces may include interfaces between specific network functions, such as an N1 interface, an N2 interface, an N3 interface, an N6 interface, an N9 interface, an N14 interface, an N16 interface, and/or one or more other interfaces. In some embodiments, one or more elements of environment 700 may communicate via a service-based architecture ("SBA"), in which a routing mesh or other suitable routing mechanism may route communications to particular network functions based on interfaces or identifiers associated with such network functions. Such interfaces may include or may be referred to as SBIs, including an Namf interface (e.g., indicating communications to be routed to AMF 615), an Nudm interface (e.g., indicating communications to be routed to UDM 709), an Npcf interface, an Nupf interface, an Nnef interface, an Nsmf interface, an Nnrf interface, an Nudr interface, an Naf interface, and/or one or more other SBIs. In some embodiments, environment 700 may be, may include, may be implemented by, and/or may be communicatively coupled to wireless network 401.

UPF 705 may include one or more devices, systems, VNFs, CNFs, etc., that receive, route, process, and/or forward traffic (e.g., user plane traffic). As discussed above, UPF 705 may communicate with UE 601 via one or more communication sessions, such as PDU sessions. Such PDU sessions may be associated with a particular network slice or other suitable QoS parameters, as noted above. UPF 705 may receive downlink user plane traffic (e.g., voice call traffic, data traffic, etc. destined for UE 601) from DN 650, and may forward the downlink user plane traffic toward UE 601 (e.g., via RAN 610). In some embodiments, multiple UPFs 705 may be deployed (e.g., in different geographical locations), and the delivery of content to UE 601 may be coordinated via the N9 interface. Similarly, UPF 705 may receive uplink traffic from UE 601 (e.g., via RAN 610), and may forward the traffic toward DN 650. In some embodiments, UPF 705 may implement, may be implemented by, may be communicatively coupled to, and/or may otherwise be associated with UPF/PGW-U 635. In some embodiments, UPF 705 may communicate (e.g., via the N4 interface) with SMF 703, regarding user plane data processed by UPF 705 (e.g., to provide analytics or reporting information, to receive policy and/or authorization information, etc.).

PCF 707 may include one or more devices, systems, VNFs, CNFs, etc., that aggregate, derive, generate, etc. policy information associated with the 5GC and/or UEs 601 that communicate via the 5GC and/or RAN 610. PCF 707 may receive information regarding policies and/or subscriptions from one or more sources, such as subscriber databases (e.g., UDM 709, UDR 713, etc.), and/or from one or more users such as, for example, an administrator associated with PCF 707. In some embodiments, the functionality of PCF 707 may be split into multiple network functions or subsystems, such as access and mobility PCF ("AM-PCF") 717, session management PCF ("SM-PCF") 719, UE PCF ("UE-PCF") 721, and so on. Such different "split" PCFs may be associated with respective SBIs (e.g., AM-PCF 717 may be associated with an Nampcf SBI, SM-PCF 719 may be associated with an Nsmpcf SBI, UE-PCF 721 may be associated with an Nuepcf SBI, and so on) via which other network functions may communicate with the split PCFs. The split PCFs may maintain information regarding policies associated with different devices, systems, and/or network functions.

NRF 711 may include one or more devices, systems, VNFs, CNFs, etc. that maintain routing and/or network topology information associated with the 5GC. For example, NRF 711 may maintain and/or provide IP addresses of one or more network functions, routes associated with one or more network functions, discovery and/or mapping information associated with particular network functions or network function instances (e.g., whereby such discovery and/or mapping information may facilitate the SBA), and/or other suitable information.

UDR 713 may include one or more devices, systems, VNFs, CNFs, etc. that provide user and/or subscriber information, based on which PCF 707 and/or other elements of environment 700 may determine access policies, QoS policies, charging policies, or the like. In some embodiments, UDR 713 may receive such information from UDM 709 and/or one or more other sources.

NEF 715 include one or more devices, systems, VNFs, CNFs, etc. that provide access to information, APIs, and/or other operations or mechanisms of the 5GC to devices or systems that are external to the 5GC. NEF 715 may maintain authorization and/or authentication information associated with such external devices or systems, such that NEF 715 is able to provide information, that is authorized to be provided, to the external devices or systems. Such information may be received from other network functions of the 5GC (e.g., as authorized by an administrator or other suitable entity associated with the 5GC), such as SMF 703, UPF 705, a charging function ("CHF") of the 5GC, and/or other suitable network function. NEF 715 may communicate with external devices or systems (e.g., external devices 654) via DN 650 and/or other suitable communication pathways.

While environment 700 is described in the context of a 5GC, as noted above, environment 700 may, in some embodiments, include or implement one or more other types of core networks. For example, in some embodiments, environment 700 may be or may include a converged packet core, in which one or more elements may perform some or all of the functionality of one or more 5GC network functions and/or one or more EPC network functions. For example, in some embodiments, AMF 615 may include, may implement, may be implemented by, and/or may otherwise be associated with MME 616; SMF 703 may include, may implement, may be implemented by, and/or may otherwise be associated with SGW 617; PCF 707 may include, may implement, may be implemented by, and/or may otherwise be associated with a PCRF (e.g., PCF/PCRF 625); NEF 715 may include, may implement, may be implemented by, and/or may otherwise be associated with a SCEF (e.g., NEF/SCEF 649); and so on.

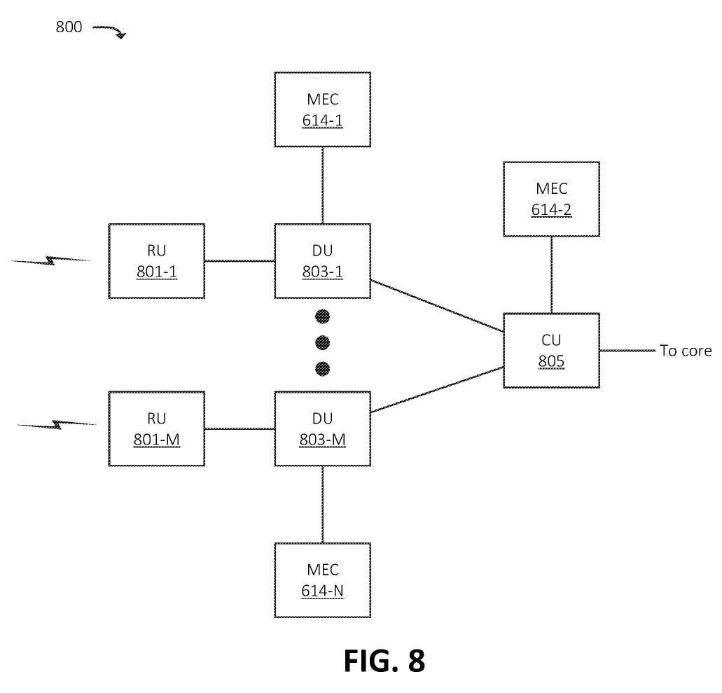

FIG. 8 illustrates an example RAN environment 800, which may be included in and/or implemented by one or more RANs (e.g., RAN 610 or some other RAN). In some embodiments, a particular RAN 610 may include one RAN environment 800. In some embodiments, a particular RAN 610 may include multiple RAN environments 800. In some embodiments, RAN environment 800 may correspond to a particular gNB 611 of RAN 610. In some embodiments, RAN environment 800 may correspond to multiple gNBs 611. In some embodiments, RAN environment 800 may correspond to one or more other types of base stations of one or more other types of RANs. As shown, RAN environment 800 may include Central Unit ("CU") 805, one or more Distributed Units ("DUs") 803-1 through 803-M (referred to individually as "DU 803," or collectively as "DUs 803"), and one or more Radio Units ("RUs") 801-1 through 801-M (referred to individually as "RU 801," or collectively as "RUs 801").

CU 805 may communicate with a core of a wireless network (e.g., may communicate with one or more of the devices or systems described above with respect to FIG. 7, such as AMF 615 and/or UPF 705) and/or some other device or system such as MEC 614. In the uplink direction (e.g., for traffic from UEs 601 to a core network), CU 805 may aggregate traffic from DUs 803, and forward the aggregated traffic to the core network. In some embodiments, CU 805 may receive traffic according to a given protocol (e.g., Radio Link Control ("RLC") traffic) from DUs 803, and may perform higher-layer processing (e.g., may aggregate/process RLC packets and generate Packet Data Convergence Protocol ("PDCP") packets based on the RLC packets) on the traffic received from DUs 803.

CU 805 may receive downlink traffic (e.g., traffic from the core network, traffic from a given MEC 614, etc.) for a particular UE 601, and may determine which DU(s) 803 should receive the downlink traffic. DU 803 may include one or more devices that transmit traffic between a core network (e.g., via CU 805) and UE 601 (e.g., via a respective RU 801). DU 803 may, for example, receive traffic from RU 801 at a first layer (e.g., physical ("PHY") layer traffic, or lower PHY layer traffic), and may process/aggregate the traffic to a second layer (e.g., upper PHY and/or RLC). DU 803 may receive traffic from CU 805 at the second layer, may process the traffic to the first layer, and provide the processed traffic to a respective RU 801 for transmission to UE 601.

RU 801 may include hardware circuitry (e.g., one or more RF transceivers, antennas, radios, and/or other suitable hardware) to communicate wirelessly (e.g., via an RF interface) with one or more UEs 601, one or more other DUs 803 (e.g., via RUs 801 associated with DUs 803), and/or any other suitable type of device. In the uplink direction, RU 801 may receive traffic from UE 601 and/or another DU 803 via the RF interface and may provide the traffic to DU 803. In the downlink direction, RU 801 may receive traffic from DU 803, and may provide the traffic to UE 601 and/or another DU 803.

One or more elements of RAN environment 800 may, in some embodiments, be communicatively coupled to one or more MECs 614. For example, DU 803-1 may be communicatively coupled to MEC 614-1, DU 803-M may be communicatively coupled to MEC 614-N, CU 805 may be communicatively coupled to MEC 614-2, and so on. MECs 614 may include hardware resources (e.g., configurable or provisionable hardware resources) that may be configured to provide services and/or otherwise process traffic to and/or from UE 601, via a respective RU 801.

For example, DU 803-1 may route some traffic, from UE 601, to MEC 614-1 instead of to a core network via CU 805. MEC 614-1 may process the traffic, perform one or more computations based on the received traffic, and may provide traffic to UE 601 via RU 801-1. As discussed above, MEC 614 may include, and/or may implement, some or all of the functionality described above with respect to UPF 705, AF 630, and/or one or more other devices, systems, VNFs, CNFs, etc. In this manner, ultra-low latency services may be provided to UE 601, as traffic does not need to traverse DU 803, CU 805, links between DU 803 and CU 805, and an intervening backhaul network between RAN environment 800 and the core network.

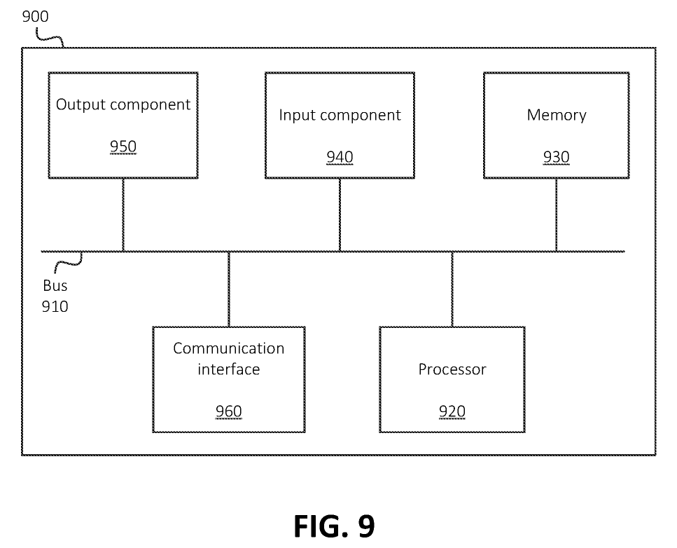

FIG. 9 illustrates example components of device 900. One or more of the devices described above may include one or more devices 900. Device 900 may include bus 910, processor 920, memory 930, input component 940, output component 950, and communication interface 960. In another implementation, device 900 may include additional, fewer, different, or differently arranged components.

Bus 910 may include one or more communication paths that permit communication among the components of device 900. Processor 920 may include a processor, microprocessor, a set of provisioned hardware resources of a cloud computing system, or other suitable type of hardware that interprets and/or executes instructions (e.g., processor-executable instructions). In some embodiments, processor 920 may be or may include one or more hardware processors. Memory 930 may include any type of dynamic storage device that may store information and instructions for execution by processor 920, and/or any type of non-volatile storage device that may store information for use by processor 920.

Input component 940 may include a mechanism that permits an operator to input information to device 900 and/or other receives or detects input from a source external to input component 940, such as a touchpad, a touchscreen, a keyboard, a keypad, a button, a switch, a microphone or other audio input component, etc. In some embodiments, input component 940 may include, or may be communicatively coupled to, one or more sensors, such as a motion sensor (e.g., which may be or may include a gyroscope, accelerometer, or the like), a location sensor (e.g., a Global Positioning System ("GPS")-based location sensor or some other suitable type of location sensor or location determination component), a thermometer, a barometer, and/or some other type of sensor. Output component 950 may include a mechanism that outputs information to the operator, such as a display, a speaker, one or more light emitting diodes ("LEDs"), etc.

Communication interface 960 may include any transceiver-like mechanism that enables device 900 to communicate with other devices and/or systems (e.g., via RAN 610, RAN 612, DN 650, etc.). For example, communication interface 960 may include an Ethernet interface, an optical interface, a coaxial interface, or the like. Communication interface 960 may include a wireless communication device, such as an infrared ("IR") receiver, a Bluetooth^{®} radio, or the like. The wireless communication device may be coupled to an external device, such as a cellular radio, a remote control, a wireless keyboard, a mobile telephone, etc. In some embodiments, device 900 may include more than one communication interface 960. For instance, device 900 may include an optical interface, a wireless interface, an Ethernet interface, and/or one or more other interfaces.

Device 900 may perform certain operations relating to one or more processes described above. Device 900 may perform these operations in response to processor 920 executing instructions, such as software instructions, processor-executable instructions, etc. stored in a computer-readable medium, such as memory 930. A computer-readable medium may be defined as a non-transitory memory device. A memory device may include space within a single physical memory device or spread across multiple physical memory devices. The instructions may be read into memory 930 from another computer-readable medium or from another device. The instructions stored in memory 930 may be processor-executable instructions that cause processor 920 to perform processes described herein. Alternatively, hardwired circuitry may be used in place of or in combination with software instructions to implement processes described herein. Thus, implementations described herein are not limited to any specific combination of hardware circuitry and software.

The foregoing description of implementations provides illustration and description, but is not intended to be exhaustive or to limit the possible implementations to the precise form disclosed. Modifications and variations are possible in light of the above disclosure or may be acquired from practice of the implementations.

For example, while series of blocks and/or signals have been described above (e.g., with regard to FIGS. 1-5), the order of the blocks and/or signals may be modified in other implementations. Further, non-dependent blocks and/or signals may be performed in parallel. Additionally, while the figures have been described in the context of particular devices performing particular acts, in practice, one or more other devices may perform some or all of these acts in lieu of, or in addition to, the above-mentioned devices.

The actual software code or specialized control hardware used to implement an embodiment is not limiting of the embodiment. Thus, the operation and behavior of the embodiment has been described without reference to the specific software code, it being understood that software and control hardware may be designed based on the description herein.

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

Further, while certain connections or devices are shown, in practice, additional, fewer, or different, connections or devices may be used. Furthermore, while various devices and networks are shown separately, in practice, the functionality of multiple devices may be performed by a single device, or the functionality of one device may be performed by multiple devices. Further, multiple ones of the illustrated networks may be included in a single network, or a particular network may include multiple networks. Further, while some devices are shown as communicating with a network, some such devices may be incorporated, in whole or in part, as a part of the network.

To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known "opt-in" or "opt-out" processes as can be appropriate for the situation and type of information. Storage and use of personal information can be in an appropriately secure manner reflective of the type of information, for example, through various access control, encryption and anonymization techniques for particularly sensitive information.

No element, act, or instruction used in the present application should be construed as critical or essential unless explicitly described as such. An instance of the use of the term "and," as used herein, does not necessarily preclude the interpretation that the phrase "and/or" was intended in that instance. Similarly, an instance of the use of the term "or," as used herein, does not necessarily preclude the interpretation that the phrase "and/or" was intended in that instance. Also, as used herein, the article "a" is intended to include one or more items, and may be used interchangeably with the phrase "one or more." Where only one item is intended, the terms "one," "single," "only," or similar language is used. Further, the phrase "based on" is intended to mean "based, at least in part, on" unless explicitly stated otherwise.

What is claimed is:

1. A device, comprising:
one or more processors configured to:
receive a UE capability policy associated with a wireless network, wherein the UE capability policy includes criteria indicating a particular set of UE capabilities; receive a request for a UE to access the wireless network; determine that the UE capability policy is applicable to the request;
determine, based on determining that the UE capability policy is applicable to the request, UE capability information associated with the UE;
compare the UE capability information, associated with the UE, to the criteria included in the UE capability policy to determine whether the UE implements the particular set of UE capabilities; and based on the comparing, selectively grant or deny the request for the UE to access the wireless network, wherein selectively granting or denying the request includes:
denying, to the UE, access to the wireless network when determining that the UE does not implement the particular set of UE capabilities, and
granting, to the UE, access to the wireless network when determining that the UE implements the particular set of UE capabilities.

2. The device of claim 1, wherein determining the UE capability information includes:
outputting a request, to a Network Function ("NF") of the wireless network, for UE capability information associated with the UE; and receiving a response from the NF that includes the UE capability information.

3. The device of claim 1, wherein the particular set of UE capabilities includes cryptography configuration information.

4. The device of claim 3, wherein the cryptography configuration information specifies at least one of:
a particular cryptography algorithm, or a quantity of bits of a key used by the particular cryptography algorithm to perform encryption techniques.

5. The device of claim 1, wherein denying access to the wireless network includes:
identifying a proxy function that implements the particular set of UE capabilities and has been granted access to the wireless network; and redirecting the UE to the proxy function, wherein the proxy function relays communications between the UE and the wireless network.

6. The device of claim 1, wherein comparing the UE capability information, associated with the UE, to the criteria included in the UE capability policy, includes determining that the UE implements a subset of the particular set of UE capabilities, and wherein granting access to the wireless network includes granting, to the UE, restricted access to the wireless network based on determining that the UE implements the subset of the particular set of UE capabilities.

7. The device of claim 1, wherein the wireless network includes a plurality of network slices, wherein the request to access the wireless network includes a request to access a particular network slice, of the plurality of network slices, wherein the UE capability policy specifies that the UE capability policy is applicable to access requests for the particular network slice, wherein determining that the UE capability policy is applicable to the request includes determining that the request and the UE capability policy are both associated with the particular network slice.

8. A non-transitory computer-readable medium, storing a plurality of processor-executable instructions to:
receive a UE capability policy associated with a wireless network, wherein the UE capability policy includes criteria indicating a particular set of UE capabilities;
receive a request for a UE to access the wireless network; determine that the UE capability policy is applicable to the request; determine, based on determining that the UE capability policy is applicable to the request, UE capability information associated with the UE; compare the UE capability information, associated with the UE, to the criteria included in the UE capability policy to determine whether the UE implements the particular set of UE capabilities; and based on the comparing, selectively grant or deny the request for the UE to access the wireless network, wherein selectively granting or denying the request includes:
denying, to the UE, access to the wireless network when determining that the UE does not implement the particular set of UE capabilities, and granting, to the UE, access to the wireless network when determining that the UE implements the particular set of UE capabilities.

9. The non-transitory computer-readable medium of claim 8, wherein determining the UE capability information includes:
outputting a request, to a Network Function ("NF") of the wireless network, for UE capability information associated with the UE; and receiving a response from the NF that includes the UE capability information.

10. The non-transitory computer-readable medium of claim 8, wherein the particular set of UE capabilities includes cryptography configuration information.

11. The non-transitory computer-readable medium of claim 10, wherein the cryptography configuration information specifies at least one of:
a particular cryptography algorithm, or a quantity of bits of a key used by the particular cryptography algorithm to perform encryption techniques.

12. The non-transitory computer-readable medium of claim 8, wherein denying access to the wireless network includes:
identifying a proxy function that implements the particular set of UE capabilities and has been granted access to the wireless network; and
redirecting the UE to the proxy function, wherein the proxy function relays communications between the UE and the wireless network.

13. The non-transitory computer-readable medium of claim 8, wherein comparing the UE capability information, associated with the UE, to the criteria included in the UE capability policy, includes determining that the UE implements a subset of the particular set of UE capabilities, and
wherein granting access to the wireless network includes granting, to the UE, restricted access to the wireless network based on determining that the UE implements the subset of the particular set of UE capabilities.

14. The non-transitory computer-readable medium of claim 8, wherein the wireless network includes a plurality of network slices, wherein the request to access the wireless network includes a request to access a particular network slice, of the plurality of network slices, wherein the UE capability policy specifies that the UE capability policy is applicable to access requests for the particular network slice, wherein determining that the UE capability policy is applicable to the request includes determining that the request and the UE capability policy are both associated with the particular network slice.

15. A method, comprising:
receiving a UE capability policy associated with a wireless network, wherein the UE capability policy includes criteria indicating a particular set of UE capabilities; receiving a request for a UE to access the wireless network; determining that the UE capability policy is applicable to the request;
determining, based on determining that the UE capability policy is applicable to the request, UE capability information associated with the UE;
comparing the UE capability information, associated with the UE, to the criteria included in the UE capability policy to determine whether the UE implements the particular set of UE capabilities; and based on the comparing, selectively granting or denying the request for the UE to access the wireless network, wherein selectively granting or denying the request includes:
denying, to the UE, access to the wireless network when determining that the UE does not implement the particular set of UE capabilities, and
granting, to the UE, access to the wireless network when determining that the UE implements the particular set of UE capabilities.

16. The method of claim 15, wherein determining the UE capability information includes:
outputting a request, to a Network Function ("NF") of the wireless network, for UE capability information associated with the UE; and receiving a response from the NF that includes the UE capability information.

17. The method of claim 15, wherein the particular set of UE capabilities includes cryptography configuration information that specifies at least one of:
a particular cryptography algorithm, or a quantity of bits of a key used by the particular cryptography algorithm to perform encryption techniques.

18. The method of claim 15, wherein denying access to the wireless network includes:
identifying a proxy function that implements the particular set of UE capabilities and has been granted access to the wireless network; and redirecting the UE to the proxy function, wherein the proxy function relays communications between the UE and the wireless network.

19. The method of claim 15, wherein comparing the UE capability information, associated with the UE, to the criteria included in the UE capability policy, includes determining that the UE implements a subset of the particular set of UE capabilities, and wherein granting access to the wireless network includes granting, to the UE, restricted access to the wireless network based on determining that the UE implements the subset of the particular set of UE capabilities.

20. The method of claim 15, wherein the wireless network includes a plurality of network slices, wherein the request to access the wireless network includes a request to access a particular network slice, of the plurality of network slices, wherein the UE capability policy specifies that the UE capability policy is applicable to access requests for the particular network slice, wherein determining that the UE capability policy is applicable to the request includes determining that the request and the UE capability policy are both associated with the particular network slice.
